(19) United States
(12) Patent Application Publication
(10) Pub. No.: US 2005/0116120 A1
(43) Pub. Date: Jun. 2, 2005

(54) Fastener for elongated members such as wire harnesses

(75) Inventor: Toshio Maruyama, Toyohashi- shi (JP)

Correspondence Address: MILES & STOCKBRIDGE PC, 1751 PINNACLE DRIVE, SUITE 500, MCLEAN, VA, 22102-3833, US

(73) Assignee: Newfrey LLC

(21) Appl. No.: 10/981,555

(22) Filed: Nov. 5, 2004

(30) Foreign Application Priority Data
Nov. 7, 2003 (JP) 2003-378189

(51) Int. Cl. F16L 3/00

(52) U.S. Cl. 248/49

(57) ABSTRACT

A fastener is capable of fastening a flexible elongated member to a support without the need of a hinge, and can be formed with a small, simple die having a two-surface configuration. In a fastener 1, a long, slender main holder 6 of a length commensurate with the support, two auxiliary holders 7 which extend transversely from opposite ends of the main holder, and engagement arms 9 which form extensions, respectively, from the auxiliary holders, and are attached to the support so as to straddle the support, are formed integrally of synthetic resin. In the main holder 6 and the auxiliary holders 7, are provided guides 13 to 15 which form a channel having a U-shaped cross section which can accommodate the elongated member 2 by the latter being pushed therein. Elastic pawls 17 to 19 can retract so that accommodation is possible when the elongated member is pushed into the channel, and then prevent the elongated member from slipping out from the channel.

### CROSS-REFERENCE TO RELATED APPLICATION

This application claims the benefit of Japanese Patent Application No. 2003-378189 filed Nov. 7, 2003, incorporated herein by reference.

### BACKGROUND OF THE INVENTION

This invention relates to a fastener for an elongated member, for fastening a flexible elongated member such as a wire, wire harness, or cable to a support such as a vehicle body frame.

Fasteners for elongated members, for fastening a flexible elongated member such as a wire, wire harness, or cable to a support such as a vehicle body frame, are known. In Japanese Laid-Open Patent Application No. H8-316659/1996, gazette publication (Patent Literature 1), for example, a fastener for fastening ABS sensor cables to auxiliary automobile equipment is disclosed. This fastener comprises a clip secured to an attachment hole in the equipment, and a wire holder coupled to that clip. The wire holder is formed by two half-ring members the ends of which are coupled by a hinge. The end of one half-ring member is coupled to the clip, while the other half-ring member turns about the hinge and works together with the first half-ring member to enclose and hold the wire. Japanese Laid-Open Utility Model No. S59-111784/1984, gazette publication (Patent Literature 2) discloses a clamp for securing a pipe to an arm in a two-wheeled vehicle. In this clamp, an arm securing part is formed in the shape of a gripper which can secure something to a long, slender, flat plate-shaped arm, and the holder for holding the pipe is formed in an elastic clamp shape opened in a C-shape coupled to the arm securing part. The side surface of the pipe is pushed in from the open portion and elastically held. Japanese Laid-Open Utility Model No. S64-7979/1989, gazette publication (Patent Literature 3) discloses a clamp for guiding and securing curved portions of pipe or hose or the like. This clamp comprises a hose holder the shape of which is matched to the curved portions of a hose or the like, and an anchor-leg clip for securing to the support in a vehicle body or the like.

In the fastener described in Patent Literature 1, the wire holder which holds the wire is formed by two half-ring members coupled by a hinge of thin material. The hinge is readily subject to failure, and, if the hinge fails, there is a danger of the wire which is being held coming loose. In order to hold the wire, moreover, an operation is necessary to turn one half-ring member toward the other half-ring member with the wire in between, so that the amount of work required is large. Furthermore, because the wire holder is configured with two half-ring members, the dies used for molding the fastener are unduly large. The clamps described in Patent Literature 2 and Patent Literature 3 are hardware for holding rigid pipe, and are not fasteners for fastening a flexible elongated member along a path. The clamp in Patent Literature 2 is only for securing pipe to a support, while the clamp described in Patent Literature 3 is configured with an anchor-leg clip as the means for securing to the support, so the manufacturing die is complex.

### BRIEF DESCRIPTIONS OF THE INVENTION

Accordingly, an object of the present invention is to provide a fastener for elongated members which is capable of fastening a flexible elongated member such as a wire along a path, without requiring a hinge, and which can be formed with a simple, small die having a two-surface configuration.

In one specific, but non-limiting embodiment, a fastener for elongated members according to this invention, for fastening a flexible elongated member such as a wire, wire harness, or cable or the like to a support such as a vehicle body frame, comprises an elongated main holder of a length commensurate with the support, two auxiliary holders which extend transversely from opposite ends of the main holder in the same direction, and engagement arms which form extensions, respectively, from the auxiliary holders, and are attached to the support so as to straddle the support. These main holder, auxiliary holders, and engagement arms are formed integrally of synthetic resin. In the main holder and the auxiliary holders, guides are provided which form a channel having a U-shaped cross-section, opened so that the elongated member can be accommodated by being pushed therein. Elastic pawls retract so that accommodation is possible when the elongated member is pushed into the channel, and which prevent the elongated member from slipping out from the channel.

According to the fastener described above, a flexible elongated member like wire can be fastened to a support along a path, without requiring a hinge in the part holding the elongated member. In addition, the fastener can be formed by a small, simple die having a two-surface configuration.

In the fastener described above, the main holder and two auxiliary holders have in common a base made of flat plate; the main holder is formed in a straight-line shape; each of the auxiliary holders extend from the main holder a short length at right angles to the main holder; and the fastener overall is formed in what is substantially a U-shape by the main holder, auxiliary holders, and engagement arms. It is preferable that the main holder guide be formed so that the channel opens at both ends of the main holder, so that the elongated member can be held in the main holder without being held in either one or both of the auxiliary holders. It is also preferable that a spring piece be provided in the main holder for elastically pressing the pawls of the engagement arms into attachment holes in the support, so that the pawls, formed at the tips of the engagement arms, do not get pulled out of the attachment holes in the support.

### BRIEF DESCRIPTION OF THE DRAWINGS

The invention will be further described in conjunction with the accompanying drawings, which illustrate a preferred (best mode) embodiment, and wherein:

FIG. 1 is a plan view of a fastener relating to one embodiment of the present invention;

FIG. 2 is a front elevation of the fastener shown in FIG. 1;

FIG. 3 is a right side elevation of the fastener shown in FIG. 2;

FIG. 4 is a section at line IV-IV of the fastener shown in FIG. 2;

FIG. 5 is a section at line V-V of the fastener shown in FIG. 2;

FIG. 6 is a view as seen from the arrow VI of the fastener shown in FIG. 2;

FIG. 7 is a front elevation of the fastener shown in FIG. 2 holding a wire harness; and

FIG. 8 is a perspective view showing how a wire harness is fastened to a frame member in a wheel suspension using the fastener of the present invention.

### DETAILED DESCRIPTION OF THE INVENTION

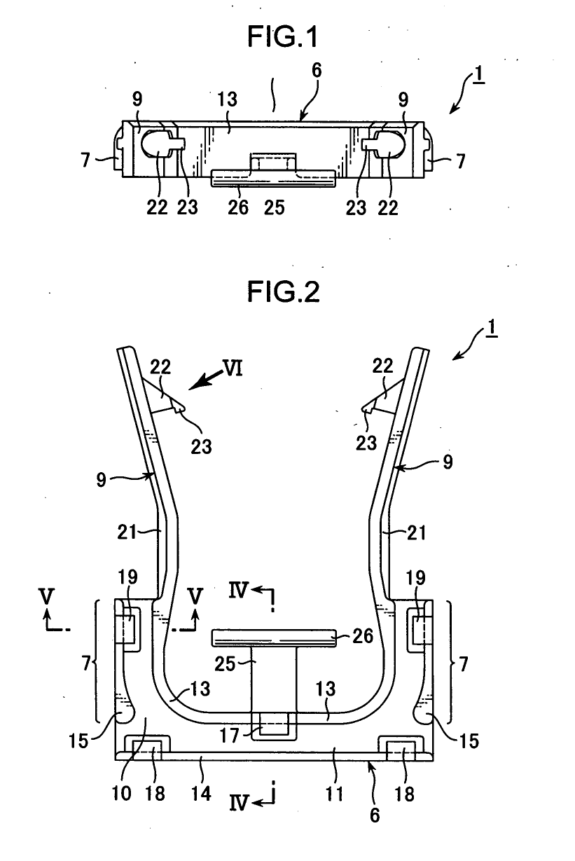

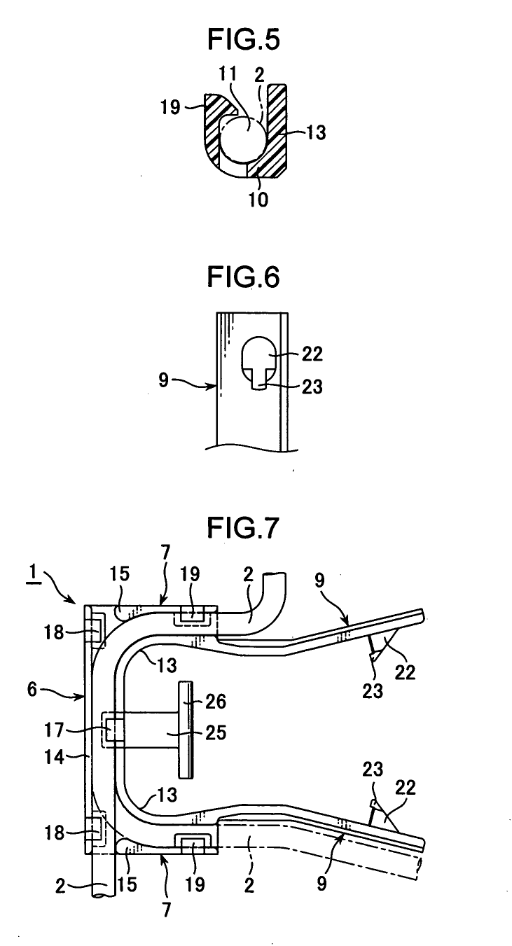

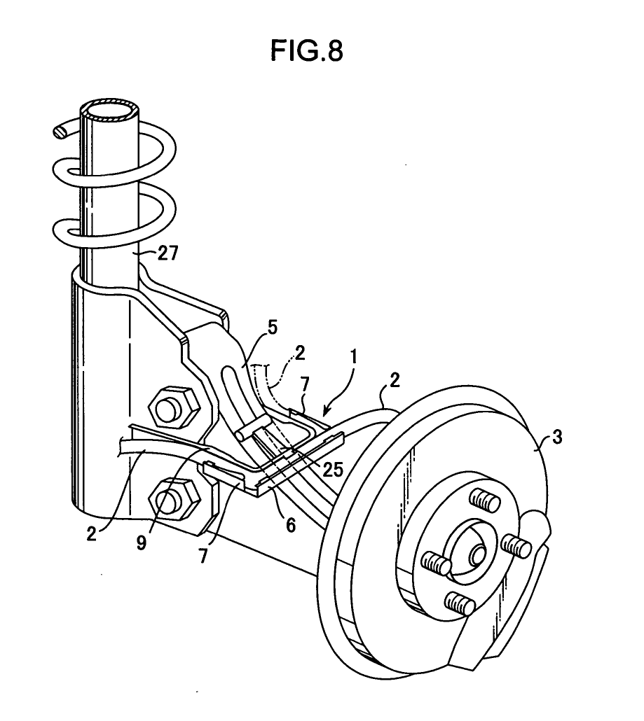

A fastener 1 for elongated members, which fastens flexible elongated members such as a wire, wire harness, or cable to a support such as a vehicle body frame or the like, will now described with reference to the drawings. The configuration of the fastener 1 is represented in FIGS. 1 to 6. FIG. 7 shows how a flexible elongated member 2 such as a wire is held in the fastener 1. As shown in FIG. 7, the fastener 1 can be pre-attached to the elongated member 2 before being secured to the support. Therefore, a manufacturer of wire, wire harnesses, or cable or the like can pre-attach the fastener 1 to the wire or the like and then deliver it to an automobile manufacturer, thereby making it possible to eliminate the work of attaching the fastener 1 to the wire or the like on the automobile production line. FIG. 8 shows how, when running an elongated member 2 such as an ABS cable from a brake drum 3 to a control panel (not shown), the path is fixed, fastening the ABS cable, etc. to a frame 5 (the support) which extends from the suspension.

In FIGS. 1 to 6, the fastener 1 comprises a long, narrow main holder 6 of a length commensurate with the width or the like of the frame 5 or other support, two auxiliary holders 7 that extend transversely from opposite ends of the main holder 6, in the same direction, and engagement arms 9 which form extensions, respectively, from the auxiliary holders 7, and which are attached to the support so as to straddle the support. The main holder 6, two auxiliary holders 7, and two engagement arms 9 are preferably molded integrally of a synthetic resin. In this embodiment, the main holder 6 and the two auxiliary holders 7 have in common a base 10 formed of flat plate. The main holder 6 is formed with a length commensurate with the size of the support, in a straight-line shape, in the left and right directions in FIG. 2, providing a width capable of accommodating the elongated member. Each of the auxiliary holders 7 extends from an end of the main holder 6, at a short length from the main holder 6, at right angles to the main holder 6. As shown in FIG. 2, the fastener 1 is formed, by the main holder 6, auxiliary holders 7, and engagement arms 9, so as to be substantially U-shaped overall.

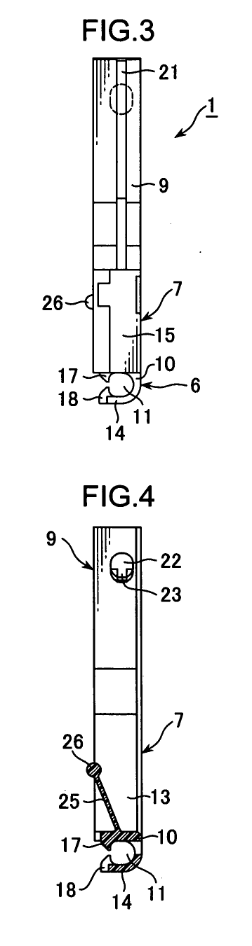

In the main holder 6 and the auxiliary holders 7 a plurality of guides, 13, 14, and 15 are provided, forming a channel 11 having a U-shaped cross-section that is open on one side (the left side in FIG. 3) so as to be able to accommodate the elongated member when it is pushed in. The first guide 13 is formed as a long continuous wall member erected from the base plate 10, extending across the main holder 6 between the two auxiliary holders 7, forming continuously one side wall of the channel 11. The first guide 13, while forming the channel 11, also maintains high strength in the base plate 10 of the fastener 1, and maintains high strength in the main holder 6 and the auxiliary holders 7. In the main holder 6, the second guide 14 is formed as a wall member erected from the base plate 10 and extending in a direction opposing end portions of the first guide 13. In the auxiliary holders 7, the third guides 15 are formed as wall members erected from the base plate 10 and extending in the longitudinal direction, opposing the first guide 13. In the first guide 13, second guide 14, and third guides 15, moreover, are provided a first elastic pawl 17, second elastic pawls 18, and third elastic pawls 19 which can retract to permit the elongated member to be accommodated in the channel 11 when it is pushed in, and which prevent the elongated member from coming out of the channel.

As shown, the first elastic pawl 17 is formed in the first guide in the portion of the channel 11 formed in the main holder 6. The two second elastic pawls 18 are formed at positions adjacent to the two ends of the portion of the channel formed in the main holder 6. The third elastic pawls 19 are formed in the third guides 15 in the portions of the channel 11 formed in the auxiliary holders 7. In this manner, in the main holder 6 and the auxiliary holders 7, are formed guides 13 to 15 and elastic pawls 17 to 19 which form the channel 11 having a U-shaped cross-section and capable of holding the elongated member merely by that elongated member being pushed in. Therefore, a flexible elongated member can be fastened along a path, without the need of a hinge, and the fastener can be formed with a small, simple die having a two-surface configuration.

As shown in FIG. 2, the second guide 14 of the main holder is formed so that the channel 11 reaches opposite ends of the main holder, and so that the channel is open there. The third guides 15 of the auxiliary holders 7 extend so as to form a channel that is continuous in the auxiliary holders 7, formed, except for the open ends of the main holder 6, as gentle curves in the portions adjacent to the main holder 6 so as to match the curved shape of the elongated member when it is made to curve toward the auxiliary holders 7. In the auxiliary holders 7, the channel is open at the ends adjacent to the engagement arms 9, and the elongated member extends out from those open ends. In this manner, by the formation of the second guide 14 which forms the channel in the main holder 6 and the third guides 15 which form the channel in the auxiliary holders 7, holding the elongated member by passing it through an auxiliary holder 7, main holder 6, and another auxiliary holder 7, or holding the elongated member accommodated in one of the auxiliary holders 7 and the main holder 6, or holding the elongated member only in the main holder 6 without accommodating it in the two auxiliary holders 7, can be selected at will.

The engagement arms 9 extend integrally from the ends of the auxiliary holders 7. The engagement arms 9 are formed so as to define a gap matching the width of the support at intermediate positions, and, with a wide taper toward the tips, so that the support can be easily attached to the fastener by pushing it in so that the support is sandwiched between the arms 9. The engagement arms 9 have the flexibility to widen toward the outside when being attached to the support. Ribs 21 are formed on the outer surfaces of the engagement arms 9, extending in the longitudinal direction, and maintain rigidity to enhance the attachment strength while maintaining the flexibility described above. Hook-shaped pawls 22 are formed on the inner sides of the tips of the engagement arms 9. At the tips of the pawls 22 are formed small projections 23 which engage attachment holes in the support, and prevent the pawls 22 engaged in the attachment holes of the support from pulling out.

In the main holder 6, furthermore, is provided a spring piece 25 which, after the fastener 1 is attached to the support, elastically presses the pawls 22 of the engagement arms 9 against edges of the attachment holes in the support so that the pawls 22 of the engagement arms 9 do not come out of the attachment holes in the support. The spring piece 25, as indicated in FIGS. 1, 2, and 4, extends from the first guide 13 of the main holder 6 as a plate-shaped piece of a certain thickness, a certain width, and a certain length. At the tip of the spring piece 25, moreover, is formed a rod-shaped pressing piece 26. This pressing piece 26 helps to make contact stably with the support, and helps the spring piece 25 to stably and flexibly butt against the support with sufficient strength.

FIG. 7 shows how the fastener 1 is pre-attached to an elongated member 2 such as a wire. In FIG. 7, the elongated member 2 passes through the channel 11 in the auxiliary holders 7 and the main holder 6. The elongated member installation layout can be set discretionally, with the elongated member 2 being run so that it extends outward from the open ends of the channel portion in the main holder 6, as indicated by the solid lines, or so that it extends to the outside from the channel portions of the auxiliary holders 7, as indicated by the dotted chain lines. In installing the elongated member 2 in the fastener 1 in a prescribed layout, when the elongated member 2 is pressed in along the open side of the channel in the main holder 6 formed by the first guide 13 and the second guide 14, and of the channel in the auxiliary holders 7 formed by the first guide 13 and the third guides 15, the first elastic pawl 17, second elastic pawls 18, and third elastic pawls 19 are bent so that they retract to the outside, and then return to their original positions, whereupon the elongated member is prevented from coming out of the channel after being accommodated in it. In this way, the fastener 1 can be pre-attached to the elongated member 2 by the manufacturer of the wire or wire harness or cable or the like and delivered to an automobile manufacturer in that condition. Thus the work of attaching the fastener 1 to the elongated member on the automobile production line can be eliminated.

FIG. 8 shows how, when running an elongated member 2 such as an ABS cable from a brake drum 3 to a control panel (not shown), the path of the elongated member 2 is fixed, fastening the ABS cable, etc. to a frame 5 (the support) which extends from the suspension 27. The engagement arms 9 which extend from the tips of the auxiliary holders 7 of the fastener 1 are attached so as to straddle the frame 5. Attachment holes are formed at prescribed positions in the frame 5, the two engagement arms 9 are pushed in so as to straddle the frame 5, and the pawls 22 at the tips of the engagement arms 9 are made to fit tightly into the attachment holes in the frame 5. By this tight fit, the projections 23 of the pawls 22 engage edges of the attachment holes and prevent the fastener 1 from coming loose. By the fastener 1 being pushed in, moreover, the pressing piece 26 strikes a back part of the frame 5 and the spring piece 25 is bent. By this bending, the pawls 22 (the projections 23 thereof are elastically pressed against edges of the attachment holes in the frame 5 so that the pawls 22 are prevented from coming out of the attachment holes in the frame 5. In this manner, making attachment to the frame 5 is a simple operation of pressing in so that the engagement arms 9 straddle the frame 5, whereupon the fastener 1 is safely secured to the frame 5, and the elongated member 2 is securely fastened to the frame 5 along an established path.

While a preferred embodiment has been shown and described, changes can be made without departing from the principles and spirit of the invention, the scope of which is defined in the accompanying claims.

1. A fastener for an elongated member, for fastening a flexible elongated member such as a wire, wire harness, or cable to a support such as a vehicle body frame, comprising:
an elongated main holder of a length commensurate with said support, two auxiliary holders which extend transversely from opposite ends of said main holder, in a same direction, and engagement arms which form extensions, respectively, from said auxiliary holders, and are attached to said support so as to straddle said support; wherein: the main holder, auxiliary holders, and engagement arms are formed integrally; in said main holder and said auxiliary holders are provided guides which form a channel having a U-shaped cross-section, opened so that said elongated member can be accommodated by being pushed therein, and elastic pawls which can retract so that accommodation is possible when said elongated member is pushed into said channel, and which prevent the elongated member from slipping out from said channel.

2. The fastener described in claim 1, wherein said main holder and said two auxiliary holders have a base plate in common, said main holder is formed in a straight-line shape, each of said auxiliary holders extends from said main holder at right angles thereto, and the fastener overall is formed so as to be substantially U-shaped by said main holder, said auxiliary holders, and said engagement arms.

3. The fastener described in claim 2, wherein a guide of said main holder is formed so that said channel opens at opposite ends of said main holder, and said elongated member can be held in said main holder without being held in one or both of said auxiliary holders.

4. The fastener described in claim 1, wherein a spring piece is provided in said main holder, that elastically presses some of the pawls, at the tips of said engagement arms, in attachment holes in said support so that the pawls do not pull out of the attachment holes in said support.
